(19) United States
(12) Patent Application Publication
(10) Pub. No.: US 2026/0187909 A1
(43) Pub. Date: Jul. 2, 2026

(54) MULTI-VIEW IMAGE GENERATION METHOD, ELECTRONIC DEVICE AND COMPUTER-READABLE STORAGE MEDIUM

(71) Applicant: UBTECH ROBOTICS CORP LTD, Shenzhen (CN)

(72) Inventor: ZHIBIN PENG, Shenzhen (CN)

(21) Appl. No.: 19/430,019

(22) Filed: Dec. 22, 2025

(30) Foreign Application Priority Data
Dec. 26, 2024 (CN) 202411950178.2

(51) Int. Cl. G06T 15/20; G06T 5/70

(52) U.S. Cl. CPC G06T 15/205; G06T 5/70; G06T 2207/20081

(57) ABSTRACT

A multi-view image generation method includes: determining target text that indicates image content of multiple target images; and for each initial image among multiple initial images, performing denoising processing on the initial image, using a target generation sub-model in a trained target diffusion model based on the initial image and the target text, to obtain one of the target images corresponding to the initial image. The target diffusion model is trained based on multiple sample sets, each of which includes multiple sample images, overlapping region features and sample text corresponding to each sample image. The sample images in each sample set are images captured of a same scene from different perspectives. The overlapping region features of each sample image are image features determined based on a local image patch in a corresponding reference sample image whose field of view overlaps with a field of view of the sample image.

### CROSS REFERENCE TO RELATED APPLICATIONS

This application claims priority to Chinese Patent Application No. CN 202411950178.2, filed Dec. 26, 2024, which is hereby incorporated by reference herein as if set forth in its entirety.

### TECHNICAL FIELD

The present disclosure generally relates to the field of computer technology, and in particular, relates to a multi-view image generation method, an electronic device and a computer-readable storage medium.

### BACKGROUND

Autonomous driving technology has become an important development direction in the fields of artificial intelligence and computer vision in recent years. Autonomous driving systems rely heavily on large amounts of image training data, which typically include multi-view information of roads, vehicles, pedestrians, and other traffic elements under different real-world scenarios and conditions. However, obtaining such data in the real world presents significant challenges. For instance, data collection is costly, often requiring specialized equipment and personnel, particularly when capturing diverse scenarios (such as adverse weather conditions, varying geographical locations, and complex traffic situations). Consequently, how to efficiently acquire multi-view image training data for autonomous driving has become a bottleneck issue in the current development of autonomous driving technology.

### BRIEF DESCRIPTION OF DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a schematic block diagram of an electronic device according to one embodiment.

FIG. 2 is an exemplary flowchart of a multi-view image generation method according to one embodiment.

FIG. 3 is an exemplary flowchart of a multi-view image generation method according to another embodiment.

FIG. 4 is a schematic diagram showing the fields of view of cameras on an autonomous vehicle.

FIG. 5 is a flowchart illustrating the steps included in step S130 in FIG. 3.

FIG. 6 is a block diagram of a Unet-based noise prediction framework according to one embodiment.

FIG. 7 is a schematic block diagram illustrating a multi-view image generation device according to one embodiment.

FIG. 8 is a schematic block diagram illustrating a multi-view image generation device according to another embodiment.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one” embodiment.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

To address the issue of insufficient autonomous driving image training data, researchers rely on virtual data generation techniques, utilizing computer-generated images and videos to supplement training datasets. This virtual data can expand the dataset by simulating different perspectives, lighting conditions, weather, and traffic scenarios. However, a significant problem with current virtual viewpoint generation technology is the inability to adequately ensure scene consistency when generating multiple viewpoints.

In practical applications, autonomous driving systems need to process multi-sensor data from different perspectives, such as front-facing cameras, side cameras, and radar sensors. The data across these different perspectives must maintain consistency to ensure that the autonomous driving model can correctly understand and infer objects and dynamics within the scene. Yet, existing virtual viewpoint generation methods often produce images for each perspective independently, leading to discrepancies in object position, size, color, etc., within the generated scenes. This introduces noise and errors during the training of autonomous driving models. Such scene inconsistency makes it difficult for autonomous driving models to accurately understand and predict dynamic changes in the environment, ultimately reducing model performance and reliability.

Current methods primarily rely on simple image transformations and stitching to generate virtual viewpoints, which cannot guarantee scene consistency across multiple perspectives. For instance, while traditional 3D rendering techniques can generate images from different perspectives, they also struggle with consistency and face challenges like insufficient accuracy and high computational resource consumption when simulating complex real-world scenes. Furthermore, these 3D methods cannot dynamically adjust the correlations between viewpoints, potentially introducing noise and errors during model training.

In response to the above challenges, embodiments of the present application provide a multi-view image generation method, apparatus, electronic device, and computer-readable storage medium. By constraining the features of overlapping regions across multiple perspectives during the training of a target diffusion model, the target generation sub-model within this diffusion model is leveraged to generate multi-view consistent image data. This reduces errors caused by scene inconsistency and can enhance the performance and reliability of autonomous driving models.

The following detailed description is provided in conjunction with the accompanying drawings, detailing some embodiments of the present application. Provided that there is no conflict, the various embodiments and features therein may be combined with each other.

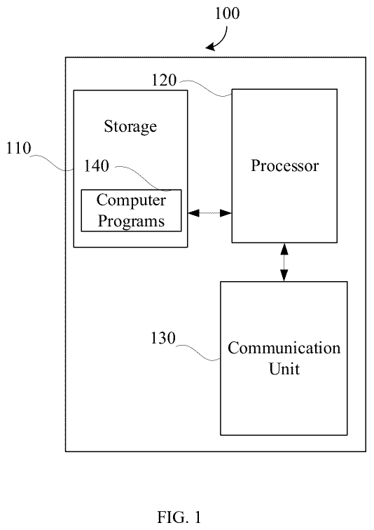

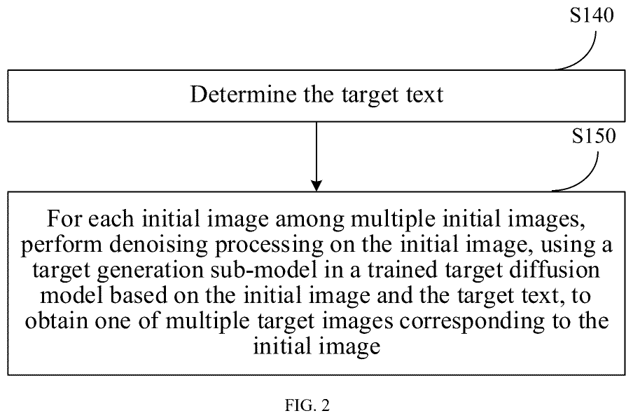

FIG. 1 is a schematic block diagram of an electronic device 100 according to one embodiment. The electronic device 100 may be, but is not limited to, a computer, a server, etc. The electronic device 100 includes a storage 110, a processor 120, and a communication unit 130. The storage 110, the processor 120, and the communication unit 130 are directly or indirectly electrically connected to one another to enable data transmission or interaction. For example, these components can be electrically connected to one another through one or more communication buses or signal lines. The processor 120 performs corresponding operations by executing the executable computer programs 140 stored in the storage 110. When the processor 120 executes the computer programs 140, the steps in the embodiments of a multi-view image generation method, such as steps S140 to S150 in FIG. 2 are implemented.

The processor 120 may be an integrated circuit chip with signal processing capability. The processor 120 may be a central processing unit (CPU), a graphics processing unit (GPU), a general-purpose processor, a network processor (NP), a digital signal processor (DSP), an application specific integrated circuit (ASIC), a field-programmable gate array (FPGA), a programmable logic device, a discrete gate, a transistor logic device, or a discrete hardware component. The general-purpose processor may be a microprocessor or any conventional processor or the like. The processor 120 can implement or execute the methods, steps, and logical blocks disclosed in the embodiments of the present disclosure.

The storage 110 may be, but not limited to, a random-access memory (RAM), a read only memory (ROM), a programmable read only memory (PROM), an erasable programmable read-only memory (EPROM), and an electrical erasable programmable read-only memory (EEPROM). The storage 110 may be an internal storage unit of the electronic device, such as a hard disk or a memory. The storage 110 may be an external storage device of the electronic device, such as a plug-in hard disk, a smart memory card (SMC), and a secure digital (SD) card, or any suitable flash cards. Furthermore, the storage 110 may include both an internal storage unit and an external storage device. The storage 110 is to store computer programs, other programs, and data required by the electronic device. The storage 110 can be used to temporarily store data that has been output or is about to be output. Upon receiving an execution instruction, the processor 120 can correspondingly execute the computer program stored on the storage 110. In one embodiment, a multi-view image generation device 200 includes at least one software functional module stored in the storage 110 in the form of software or firmware. The processor 120 executes various functional applications and data processing, thereby implementing the multi-view image generation method described in the embodiments of the present application, by running the software programs and modules stored in the storage 110, such as the at least one software functional module of the multi-view image generation device 200.

Exemplarily, the one or more computer programs 140 may be divided into one or more modules/units, and the one or more modules/units are stored in the storage 110 and executable by the processor 120. The one or more modules/units may be a series of computer program instruction segments capable of performing specific functions, and the instruction segments are used to describe the execution process of the one or more computer programs 140 in the electronic device.

The communication unit 130 is to establish a communication connection between the electronic device 100 and other communication terminals via a network, and is to transmit and receive data through the network.

It should be noted that the block diagram shown in FIG. 1 is only an example of the electronic device. The electronic device may include more or fewer components than what is shown in FIG. 1, or have a different configuration than what is shown in FIG. 1. Each component shown in FIG. 1 may be implemented in hardware, software, or a combination thereof.

FIG. 2 is an exemplary flowchart of a multi-view image generation method according to one embodiment. This method can be implemented by the electronic device described above. The specific process of the multi-view image generation method will be described in detail below. In one embodiment, the method may include steps S140 to S150

Step S140: Determine the target text.

Step S150: For each initial image among multiple initial images, perform denoising processing on the initial image, using a target generation sub-model in a trained target diffusion model based on the initial image and the target text, to obtain one of multiple target images corresponding to the initial image.

In one embodiment, the electronic device may store a pre-trained target diffusion model. The target diffusion model is trained based on multiple sample sets. Each sample set includes multiple sample images, the overlapping region features corresponding to each sample image, and the sample text corresponding to each sample image. The multiple sample images in a sample set are images obtained by capturing images of the same scene from different perspectives. The scenes corresponding to different sample sets may be different. The overlapping region features of each sample image are image features determined based on the local image patches of corresponding reference sample images whose fields of view overlap with that of the sample image. The reference sample images and the sample image are in the same sample set. For example, if a sample set includes sample image 1 and sample image 2 and the viewpoints corresponding to sample image 1 and sample image 2 have overlapping fields of view, then the real-world region corresponding to the overlapping field of view is partially captured in both sample image 1 and sample image 2. The overlapping region feature corresponding to sample image 1 may be determined based on the portion of sample image 2 that captures this region, i.e., the above-described local image patch.

When multiple-view images need to be generated, target text can be determined first. This target text is to indicate the image content of the generated multi-view images, that is, to indicate the image content of multiple target images. The specific content of the target text can be determined based on actual needs, for example, to indicate the generation of multiple target images corresponding to a rainy day. Multiple initial images can be determined in any way. The number of initial images is the same as the number of multi-view images to be generated, that is, the same as the number of viewpoints. These initial images can be the same image or different images. For each initial image, the target generation sub-model in the target diffusion model can be used to denoise the initial image based on the initial image and the target images, thereby obtaining the target image corresponding to the initial image. In this way, the target generation sub-model can be used to obtain multiple target images based on the target text and multiple initial images. These target images satisfy the scene consistency requirements and the correlation between viewpoints can be dynamically adjusted through the target text.

In one embodiment, by constraining the overlapping region features of multiple viewpoints during the training process of the target diffusion model, the target generation sub-model in the target diffusion model is used to generate multi-view consistent image data, reducing errors caused by scene inconsistency, and improving the performance and reliability of the autonomous driving model. The following first describes how to obtain the target diffusion model.

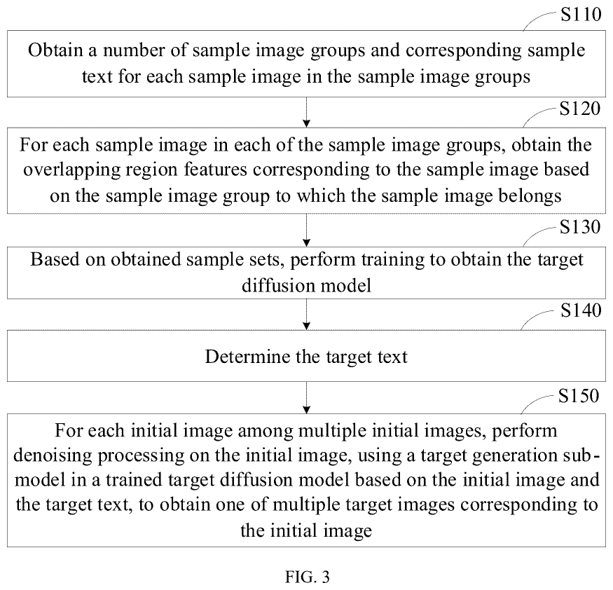

FIG. 3 is another exemplary flowchart of a multi-view image generation method according to one embodiment. In the embodiment, the method may further include steps S110 to S130 before step S140.

Step S110: Obtain a number of sample image groups and corresponding sample text for each sample image in the sample image groups.

Step S120: For each sample image in each of the sample image groups, obtain the overlapping region features corresponding to the sample image based on the sample image group to which the sample image belongs.

Step S130: Based on obtained sample sets, perform training to obtain the target diffusion model.

In a real-world environment, multiple cameras used to capture multi-view images typically have partially overlapping fields of view. Since the relative positions of the cameras remain fixed, the overlapping regions also remain constant. This characteristic can be utilized to impose constraints on viewpoint consistency.

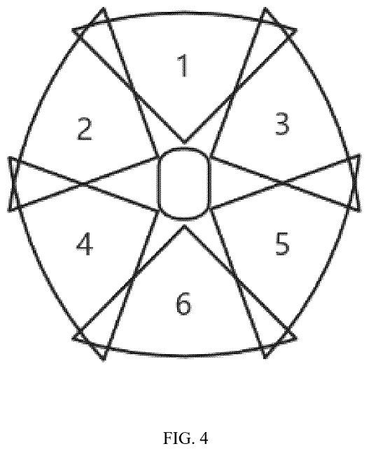

For example, as shown in the schematic diagram of the visible regions of multiple cameras of an unmanned vehicle in FIG. 4, camera 1 has partially overlapping fields of view with camera 2 and camera 3. Because the relative positions among the cameras remain fixed, the overlapping regions likewise remain unchanged. This characteristic can therefore be used to impose constraints on viewpoint consistency.

Multiple sample image groups may be captured. Each sample image group includes sample images of the same scene captured from multiple viewpoints.

Optionally, as one possible implementation, as shown in FIG. 4, six cameras may be mounted on the unmanned vehicle. The images simultaneously captured by these six cameras may be treated as one frame of data, where the frame of data includes one image captured by each of the six cameras. Such a frame of data may be used as one sample image group.

For a given sample image group, sample text corresponding to the respective sample images in the sample image group may be obtained. Optionally, the sample text corresponding to the sample images may be obtained through manual annotation.

Alternatively, a pretrained first image encoder may be used to encode (i.e., extract features from) a sample image to obtain first sample image features corresponding to the sample image. Subsequently, a text generation model may generate sample text corresponding to the sample image based on the first sample image features. By repeatedly performing the above processing for each sample image, the respective sample text corresponding to the sample images may be obtained. The first image encoder may be, but is not limited to, a contrastive language-image pretraining (CLIP) model, a bidirectional encoder representations from transformers (BERT) model, or the like. The text generation model may be, but is not limited to, a GPT-3 model. In this manner, the first image encoder and the text generation model may be used to generate, through a mapping between image features and text features, a description matching the image content of each sample image as the sample text corresponding to the sample image.

After performing the above processing on each sample image in the sample image groups, the sample text corresponding to each sample image may be obtained, thereby obtaining image-text pairs.

Each sample image group includes multiple sample images. The following processing may be performed for each sample image group: for each sample image in the sample image group, reference sample image(s) corresponding to the sample image within the sample image group is determined, where the reference sample image(s) belong to the same sample group as the sample image and have an overlapping field of view with the sample image. Then, for each reference sample image, a local image corresponding to the portion of the reference sample image whose field of view overlaps with that of the sample image is determined, i.e., the local image is a partial image extracted from the reference sample image. Next, the local image is mapped to the coordinate system used by the sample image to obtain a target local image. Finally, an overlapping region feature corresponding to the sample image is obtained based on the target local image. The overlapping region feature is obtained by encoding (i.e., extracting features from) the target local image.

As shown in the scenario of FIG. 4, each frame of data includes six images (i.e., one sample image group includes six sample images). The mapping relationships between images having overlapping regions may be computed first. In many autonomous-driving datasets (e.g., nuScenes), one view typically overlaps with the views on its left and right sides. Therefore, for the i-th view (i.e., the i-th sample image in the sample image group), only the left view iₗ and the right view iᵣ need to be considered. A mapping relationship corresponding to the overlapping region from the right view iᵣ to the i-th view may be obtained, and the mapping function is denoted as g(*). Accordingly, a coordinate a in the right view iᵣ is mapped to a coordinate b in the i-th view (i.e., b=g(a)). With the mapping relationship available, the respective local images in the left view iₗ and the right view iᵣ that correspond to the overlapping field of view with the i-th view may first be determined. Then, the mapping relationship is applied to the local images to obtain two target local images under the coordinate system of the i-th view. Subsequently, two sets of overlapping region features are obtained based on the two target local images, where one set corresponds to the left view iₗ, and the other set corresponds to the right view iᵣ.

Through the above processing, multiple sample sets may be obtained. Each sample set includes multiple samples. Each sample may include a sample image, overlapping region features corresponding to the sample image, and sample text corresponding to the sample image. The sample images of a sample set constitute a sample image group.

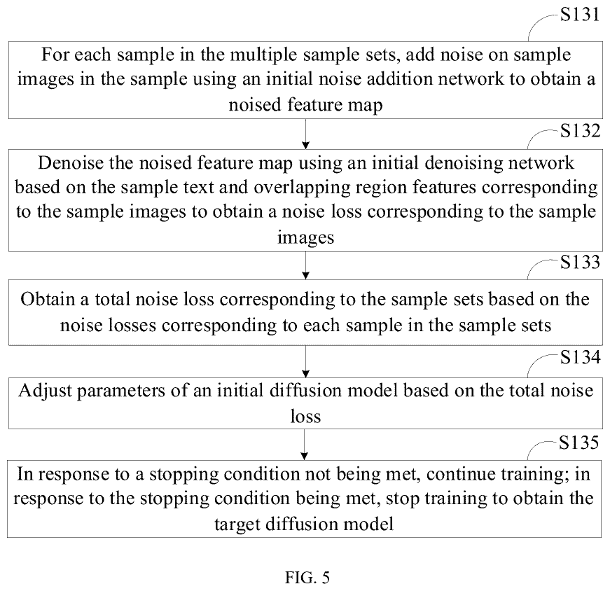

With the multiple sample sets obtained, the initial diffusion model may be trained in the manner shown in FIG. 5 to obtain a target diffusion model. FIG. 5 illustrates a flowchart of the steps included in step S130 of FIG. 3. In one embodiment, step S130 may include step S131 through step S135.

Step S131: For each sample in the multiple sample sets, add noise on sample images in the sample using an initial noise addition network to obtain a noised feature map.

Step S132: Denoise the noised feature map using an initial denoising network based on the sample text and overlapping region features corresponding to the sample images to obtain a noise loss corresponding to the sample images.

Step S133: Obtain a total noise loss corresponding to the sample sets based on the noise losses corresponding to each sample in the sample sets.

Step S134: Adjust parameters of an initial diffusion model based on the total noise loss, wherein the initial diffusion model includes the initial noise addition network and the initial denoising network.

Step S135: In response to a stopping condition not being met, continue training; in response to the stopping condition being met, stop training to obtain the target diffusion model.

In one embodiment, the initial diffusion model may include an initial noise addition network and an initial denoising network. During training, for each sample set, the initial noise addition network may be used to perform noise addition processing on each sample image in the sample set to obtain a noised feature map. The initial denoising network is then used to perform denoising processing on each obtained noised feature map, thereby completing the noise addition and denoising processing for the sample images. For the noise addition and denoising of each sample image, a noise loss of the sample image is calculated, and a total noise loss corresponding to the sample set is further calculated. The parameters of the initial diffusion model may then be adjusted based on the obtained total noise loss of the sample set. It is further determined whether a training-stopping condition is satisfied. If the condition is satisfied, the current initial diffusion model may be taken as the trained target diffusion model. If the training-stopping condition is not satisfied, the foregoing process may be repeated based on the sample set until the training-stopping condition is satisfied.

For a given sample set, assume the random time step corresponding to the sample set is t. The Gaussian noise used in the noise addition process of the sample images in this sample set corresponds to the random time step t. The purpose of the initial denoising network is to predict the pre-noise feature zₜ₋₁, so that the noise (i.e., the estimated noise) between t−1 and t can be determined based on the pre-noise feature zₜ₋₁ and the post-noise feature zₜ. The noise loss is then computed based on this estimated noise and the noise determined from the random time step t.

The initial denoising network may obtain a cross-attention output based on the sample text and the overlapping region features corresponding to the sample image, and perform denoising based on the output. This allows the target model to better understand the relationships among the images to be generated, the text, and the overlapping regions.

The cross-attention output is obtained based on a Query matrix, a Key matrix, and a Value matrix. The Query matrix is obtained based on the sample images, and the Key matrix and the Value matrix are obtained based on the sample text and overlapping region features corresponding to the sample images;

The total noise loss may be obtained by performing a mean squared error (MSE) loss calculation, which may be expressed as: [symbol] =E_{x,ϵ,T,C}[∥ϵ−ϵ_{θ}(xₜ, T, C)∥²], where E denotes the expectation, representing the average noise loss corresponding to the sample images in a sample set; x represents the input raw data sample (i.e., the sample image); ϵ denotes the standard normal noise, and xₜ denotes the noised image at time step t; ϵ_{θ}(*) denotes the model predicted noise; the parameter θ represents the model weights (i.e., model parameters); T represents the control condition of the sample text, and C represents the control condition of the overlapping region features.

Optionally, it may be determined that the stop-training condition is met when the total noise loss is less than a preset value, or when the number of model iterations reaches a preset number. The stop-training condition may be configured based on actual requirements, and is therefore not specifically limited herein.

For example, after a certain number of training iterations, if the loss is observed to continuously decrease and gradually stabilize, samples may be periodically generated for quality evaluation to observe whether the visual quality becomes stable. If the loss function value is lower than a threshold and the generation results exhibit satisfactory quality, the corresponding model parameters may be determined as the parameters of the target diffusion model. If the loss function remains higher than the threshold, this indicates inadequate training, and the learning rate or early-stopping strategy may need to be adjusted to continue the training.

In one embodiment, the initial diffusion model may further include a second image encoder, an image decoder, and a text encoder. The second image encoder may first be used to encode the sample image (i.e., to obtain second sample image features), after which noise is added to the encoded features. The noised data is then input into the initial denoising network. The text encoder may be used to encode the sample text, and the encoding result together with the corresponding overlapping region features may be fed into the initial denoising network. The initial denoising network performs denoising based on the received data, and the final denoised result is input into the image decoder for decoding so as to obtain a generated image corresponding to the input sample image. Here, the image decoder may be, but is not limited to, a VAE decoder.

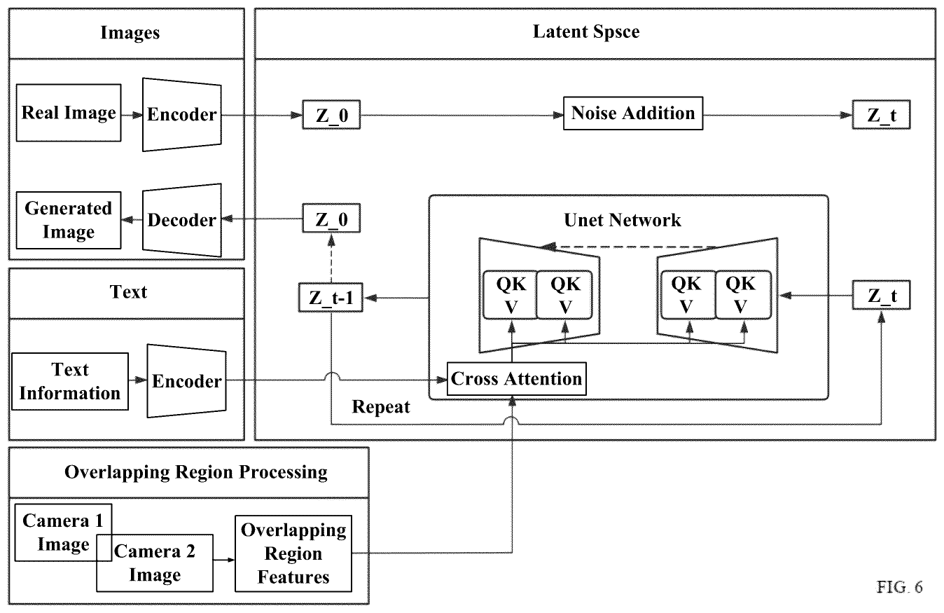

As a possible implementation, the initial denoising network may be a U-Net network (also referred to as a U-Net denoising network). The training process described above is briefly illustrated below with reference to FIG. 6.

As shown in FIG. 6, the initial diffusion model may include a second image encoder (i.e., the encoder shown in FIG. 6), an initial noise addition network, a U-Net network, an image decoder (i.e., the decoder shown in FIG. 6), and a text encoder (i.e., the encoder corresponding to text in FIG. 6).

For each sample image in a sample set, the text features corresponding to the sample image (i.e., the features obtained after the sample text is processed by the text encoder) and the overlapping region features are used as control conditions and fed into the U-Net denoising network. The second image encoder is used to encode the sample image (i.e., the real image shown in FIG. 6) to obtain an image feature z₀. In the latent feature space, for the currently used sample set, a random time step tis selected, and Gaussian noise corresponding to the random time step t is applied to the image feature z₀ of each sample image to obtain a noised feature zₜ. Meanwhile, the time step t is converted into a vector.

The function of the U-Net denoising network is to predict the pre-noise feature zₜ₋₁. In the description above, the text features corresponding to the sample text and the overlapping region features are used as control conditions and input into the U-Net denoising network. A cross-attention mechanism based on a Transformer may then be applied, enabling the target diffusion model to better understand the relationship among the images to be generated, the text, and the overlapping regions. Assume that the current sample image has an image feature X_{I}, the sample text has a corresponding text feature X_{T}, and the overlapping region feature is X_{C}. The equations for calculating cross-attention are expressed as follows:

$$\{ \begin{matrix}Q = {X}_{I} {W}_{Q} \\ K = ( {X}_{T} + {X}_{C} ) {W}_{K} , \\ V = ( {X}_{T} + {X}_{C} ) {W}_{V}\end{matrix}$$

where, Q denotes the Query matrix, K denotes the Key matrix, and V denotes the Value matrix; the matrices W_{Q}, W_{K}, and W_{V} represent the learned weight matrices used to generate Q, K, and V, respectively.

The cross-attention output can be calculated according to the following equation: Attention

$$Attention ( Q , K , V ) = Softmax ( \frac{Q {K}^{T}}{\sqrt{{d}_{k}}} ) V ,$$

where QK^{T} represents the dot product between the Query matrix and the transpose of the Key matrix, producing an attention score matrix that reflects the correlation between positions in the input sequence; \sqrt{dₖ} is a scaling factor, typically set to the square root of the dimensionality dₖ of the Key matrix, used to prevent the dot-product values from becoming excessively large when the dimensionality is high, which would otherwise affect the gradients and computation of the Softmax function; and the Softmax function is applied to convert the attention scores into weights.

By the above approach, text information and overlapping region information between two cameras are input to the model, which enables cross-view consistency to be effectively constrained. Text, images, and overlapping region features are integrated through a cross-attention mechanism to capture correlations between different portions of the input data. This is accomplished by generating the Query, Key, and Value matrices via linear transformations, followed by computing attention scores and performing weighted summation, which enhances the model's ability to capture multiple features and associations.

For the noised feature zₜ corresponding to each sample image in a sample set, the U-Net denoising network progressively removes Gaussian noise to obtain the latent image encoding z₀, which is then decoded into a generated image via the second image decoder.

After completing the noise addition and denoising processing for a sample image, the noise loss corresponding to that sample image can be calculated. Subsequently, for a sample set, the total noise loss corresponding to the set may be computed as the average of the noise losses of all sample images within the set. Multiple sample sets and their corresponding total noise losses may then be used to adjust the parameters of the initial diffusion model, thereby obtaining the target diffusion model.

During training, when denoising a sample image, the camera parameter information corresponding to the sample image may also be input into the U-Net denoising network, and the network performs denoising in conjunction with the camera parameter information. The camera parameter information may describe details of the camera that captured the sample image, such as extrinsic parameters, intrinsic parameters, position, and the like. Within a sample set, the camera parameter information may differ for each sample image.

The target generation sub-model in the target diffusion model may include a target image encoder, a target image decoder, a target text encoder, and a target denoising network. Specifically, the target image encoder corresponds to the second image encoder of the initial diffusion model at the end of training, the target image decoder corresponds to the image decoder of the initial diffusion model at the end of training, the target text encoder corresponds to the text encoder of the initial diffusion model at the end of training, and the target denoising network corresponds to the initial denoising network of the initial diffusion model at the end of training.

In this case, for each of the multiple initial images, the target image encoder is used to encode the initial image to obtain initial image features. The target text encoder is used to encode the target text to obtain text features. The target denoising network then denoises the initial image features based on the initial image features and the text features to obtain denoised initial image features. Finally, the target image decoder decodes the denoised initial image features to generate the target image.

When camera parameter information is used during training, correspondingly, the target generation sub-model may generate a target image from the perspective defined by the camera parameter information, based on the camera parameter information corresponding to the initial image, the initial image itself, and the target text. Each of the multiple initial images may correspond to different camera parameter information. When the target generation sub-model includes the target image encoder, target image decoder, target text encoder, and target denoising network as described above, the camera parameter information corresponding to the initial image may be encoded and then input, together with the initial image features and text features corresponding to the initial image, into the target denoising network. The final output of the target denoising network is then decoded by the target image decoder to obtain the target image corresponding to the initial image, which aligns with the camera parameter information of that initial image.

To maintain scene consistency when generating images from multiple virtual viewpoints, in one embodiment, the model is trained by constraining the overlapping-region features across multiple viewpoints to obtain the target diffusion model. The target generation sub-model within the target diffusion model may then be used to generate multi-view consistent images. The resulting multi-view images can serve as training data for autonomous driving models, reducing errors caused by scene inconsistencies and improving the performance and reliability of the autonomous driving models. The above approach may serve as a method for generating scene-consistent vehicle image data, enabling the acquisition of multi-view image data for training autonomous driving models.

It should be understood that sequence numbers of the foregoing processes do not mean an execution sequence in the above-mentioned embodiments. The execution sequence of the processes should be determined according to functions and internal logic of the processes, and should not be construed as any limitation on the implementation processes of the above-mentioned embodiments.

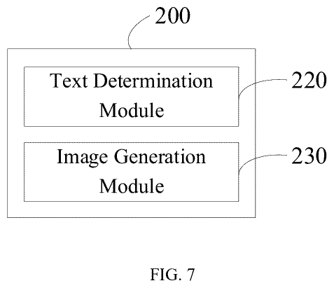

In order to implement the steps described in the above embodiments and their possible variations, an implementation of a multi-view image generation device 200 is provided below. Optionally, the multi-view image generation device 200 may adopt the hardware structure of the electronic device 100 shown in FIG. 1. Further, with reference to FIG. 7, which is a block diagram illustrating one implementation of the multi-view image generation device 200, it should be noted that the basic principle and technical effects of the multi-view image generation device 200 provided in this embodiment are the same as those in the embodiments described above. For brevity, aspects not explicitly mentioned in this embodiment may be understood with reference to the corresponding content in the above embodiments.

In one embodiment, the multi-view image generation device 200 may include a text determination module 220 and an image generation module 230. The text determination module 220 is to determine target text that indicates image content of a number of target images. The image generation module 230 is to, for each initial image among a number of initial images, perform denoising processing on the initial image, using a target generation sub-model in a trained target diffusion model based on the initial image and the target text, to obtain one of the target images corresponding to the initial image. The target diffusion model is trained based on a plurality of sample sets, each of which comprises a number of sample images, overlapping region features and sample text corresponding to each of the sample images. The sample images in each of the sample sets are images captured of a same scene from different perspectives. The overlapping region features of each sample image of the sample images are image features determined based on a local image patch in a corresponding reference sample image whose field of view overlaps with a field of view of the sample image, and the reference sample image and the sample image belong to a same sample set of the sample sets.

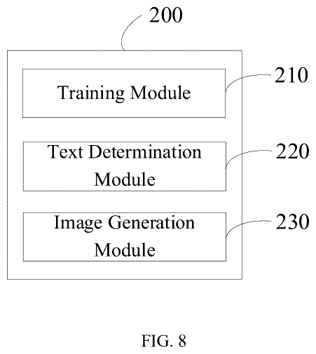

With reference to FIG. 8, which is a block diagram illustrating another implementation of the multi-view image generation device 200, the multi-view image generation device 200 may further include a training module 210. The training module 210 is to: obtain a number of sample image groups and corresponding sample text for each sample image in the sample image groups, wherein each sample image group among the sample image groups includes a number of sample images captured of the same scene from different perspectives; for each sample image in each of the sample image groups, obtain the overlapping region features corresponding to the sample image based on the sample image group to which the sample image belongs; based on a number of sample sets obtained, perform training to obtain the target diffusion model, wherein each sample in the sample sets includes a number of sample images, overlapping region features, and sample text corresponding to the sample images.

Optionally, the above modules may be stored in the storage 110 shown in FIG. 1 in the form of software or firmware, or may be embedded in the operating system (OS) of the electronic device 100, and may be executed by the processor 120 shown in FIG. 1. At the same time, the data, program code, and other information required to execute the above modules may be stored in the storage 110.

Another aspect of the present disclosure is directed to a non-transitory computer-readable medium storing instructions which, when executed, cause one or more processors to perform the methods, as discussed above. The computer-readable medium may include volatile or non-volatile, magnetic, semiconductor, tape, optical, removable, non-removable, or other types of computer-readable medium or computer-readable storage devices. For example, the computer-readable medium may be the storage device or the memory module having the computer instructions stored thereon, as disclosed. In one embodiment, the computer-readable medium may be a disc or a flash drive having the computer instructions stored thereon.

In summary, by executing the above-described methods, multiple-view consistent image data can be generated using the target generation sub-model within the target diffusion model, by constraining the overlapping region features across multiple viewpoints during the training of the target diffusion model. This reduces errors caused by scene inconsistencies and can improve the performance and reliability of autonomous driving models.

It should be understood that the disclosed device and method can also be implemented in other manners. The device embodiments described above are merely illustrative. For example, the flowcharts and block diagrams in the accompanying drawings illustrate the architecture, functionality and operation of possible implementations of the device, method and computer program product according to embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In addition, functional modules in the embodiments of the present disclosure may be integrated into one independent part, or each of the modules may be independent, or two or more modules may be integrated into one independent part. in addition, functional modules in the embodiments of the present disclosure may be integrated into one independent part, or each of the modules may exist alone, or two or more modules may be integrated into one independent part. When the functions are implemented in the form of a software functional unit and sold or used as an independent product, the functions may be stored in a computer-readable storage medium. Based on such an understanding, the technical solutions in the present disclosure essentially, or the part contributing to the prior art, or some of the technical solutions may be implemented in a form of a software product. The computer software product is stored in a storage medium and includes several instructions for instructing a computer device (which may be a personal computer, a server, a network device, or the like) to perform all or some of the steps of the methods described in the embodiments of the present disclosure. The foregoing storage medium includes: any medium that can store program code, such as a USB flash drive, a removable hard disk, a read-only memory (ROM), a random access memory (RAM), a magnetic disk, or an optical disc.

A person skilled in the art can clearly understand that for the purpose of convenient and brief description, for specific working processes of the device, modules and units described above, reference may be made to corresponding processes in the embodiments of the foregoing method, which are not repeated herein.

In the embodiments above, the description of each embodiment has its own emphasis. For parts that are not detailed or described in one embodiment, reference may be made to related descriptions of other embodiments.

A person having ordinary skill in the art may clearly understand that, for the convenience and simplicity of description, the division of the above-mentioned functional units and modules is merely an example for illustration. In actual applications, the above-mentioned functions may be allocated to be performed by different functional units according to requirements, that is, the internal structure of the device may be divided into different functional units or modules to complete all or part of the above-mentioned functions. The functional units and modules in the embodiments may be integrated in one processing unit, or each unit may exist alone physically, or two or more units may be integrated in one unit. The above-mentioned integrated unit may be implemented in the form of hardware or in the form of software functional unit. In addition, the specific name of each functional unit and module is merely for the convenience of distinguishing each other and are not intended to limit the scope of protection of the present disclosure. For the specific operation process of the units and modules in the above-mentioned system, reference may be made to the corresponding processes in the above-mentioned method embodiments, and are not described herein.

A person having ordinary skill in the art may clearly understand that the exemplificative units and steps described in the embodiments disclosed herein may be implemented through electronic hardware or a combination of computer software and electronic hardware. Whether these functions are implemented through hardware or software depends on the specific application and design constraints of the technical schemes. Those ordinary skilled in the art may implement the described functions in different manners for each particular application, while such implementation should not be considered as beyond the scope of the present disclosure.

In the embodiments provided by the present disclosure, it should be understood that the disclosed apparatus (device)/terminal device and method may be implemented in other manners. For example, the above-mentioned apparatus (device)/terminal device embodiment is merely exemplary. For example, the division of modules or units is merely a logical functional division, and other division manner may be used in actual implementations, that is, multiple units or components may be combined or be integrated into another system, or some of the features may be ignored or not performed.

In addition, the shown or discussed mutual coupling may be direct coupling or communication connection, and may also be indirect coupling or communication connection through some interfaces, devices or units, and may also be electrical, mechanical or other forms.

The units described as separate parts may or may not be physically separate, and parts displayed as units may or may not be physical units, may be located in one position, or may be distributed on a plurality of network units. Some or all of the modules may be selected according to actual requirements to achieve the objectives of the solutions of the embodiments.

The functional units and modules in the embodiments may be integrated in one processing unit, or each unit may exist alone physically, or two or more units may be integrated in one unit. The above-mentioned integrated unit may be implemented in the form of hardware or in the form of software functional unit.

When the integrated module/unit is implemented in the form of a software functional unit and is sold or used as an independent product, the integrated module/unit may be stored in a non-transitory computer-readable storage medium. Based on this understanding, all or part of the processes in the method for implementing the above-mentioned embodiments of the present disclosure may also be implemented by instructing relevant hardware through a computer program. The computer program may be stored in a non-transitory computer-readable storage medium, which may implement the steps of each of the above-mentioned method embodiments when executed by a processor. In which, the computer program includes computer program codes which may be the form of source codes, object codes, executable files, certain intermediate, and the like. The computer-readable medium may include any primitive or device capable of carrying the computer program codes, a recording medium, a USB flash drive, a portable hard disk, a magnetic disk, an optical disk, a computer memory, a read-only memory (ROM), a random-access memory (RAM), electric carrier signals, telecommunication signals and software distribution media. It should be noted that the content contained in the computer readable medium may be appropriately increased or decreased according to the requirements of legislation and patent practice in the jurisdiction. For example, in some jurisdictions, according to the legislation and patent practice, a computer readable medium does not include electric carrier signals and telecommunication signals.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A computer-implemented multi-view image generation method comprising:
determining target text that indicates image content of a plurality of target images; and
for each initial image among a plurality of initial images, performing denoising processing on the initial image, using a target generation sub-model in a trained target diffusion model based on the initial image and the target text, to obtain one of the plurality of target images corresponding to the initial image;
wherein the target diffusion model is trained based on a plurality of sample sets, each of which comprises a plurality of sample images, overlapping region features and sample text corresponding to each of the plurality of sample images; the plurality of sample images in each of the sample sets are images captured of a same scene from different perspectives; the overlapping region features of each sample image of the plurality of sample images are image features determined based on a local image patch in a corresponding reference sample image whose field of view overlaps with a field of view of the sample image, and the reference sample image and the sample image belong to a same sample set of the plurality of sample sets.

2. The method of claim 1, wherein for each initial image among the plurality of initial images, performing denoising processing on the initial image, using the target generation sub-model in the trained target diffusion model based on the initial image and the target text, to obtain one of the plurality of target images corresponding to the initial image, comprises:
through the target generation sub-model and based on camera parameter information corresponding to the initial image, the initial image, and the target text, obtaining the one of the plurality of target images from a perspective corresponding to the camera parameter information, wherein the plurality of initial images correspond to different camera parameter information and the plurality of sample sets further comprises the camera parameter information corresponding to each sample image.

3. The method of claim 1, wherein the target generation sub-model comprises a target image encoder, a target image decoder, a target text encoder, and a target denoising network; performing denoising processing on the initial image, using the target generation sub-model in the trained target diffusion model based on the initial image and the target text, to obtain one of the plurality of target images corresponding to the initial image comprises:
encoding, by the target image encoder, the initial image to obtain initial image features;
encoding, by the target text encoder, the target text to obtain text features;
denoising, by the target denoising network, the initial image features based on the initial image features and text features to obtain denoised initial image features; and
decoding, by the target image decoder, the denoised initial image features to obtain the one of the plurality of target images corresponding to the initial image.

4. The method of claim 1, further comprising:
obtaining a plurality of sample image groups and corresponding sample text for each sample image in the plurality of sample image groups, wherein each sample image group among the plurality of sample image groups comprises a plurality of sample images captured of the same scene from different perspectives;
for each sample image in each of the plurality of sample image groups, obtaining the overlapping region features corresponding to the sample image based on the sample image group to which the sample image belongs;
based on a plurality of sample sets obtained, performing training to obtain the target diffusion model, wherein each sample in the plurality of sample sets comprises a plurality of sample images, overlapping region features, and sample text corresponding to the sample images.

5. The method of claim 4, wherein based on the obtained plurality of sample sets, performing training to obtain the target diffusion model comprises:
for each sample in the plurality of sample sets, adding noise on sample images in the sample using an initial noise addition network to obtain a noised feature map;
denoising the noised feature map using an initial denoising network based on the sample text and overlapping region features corresponding to the sample images to obtain a noise loss corresponding to the sample images, wherein the initial denoising network is configured to perform denoising based on an output of cross-attention, the output is obtained based on a Query matrix, a Key matrix, and a Value matrix, the Query matrix is obtained based on the sample images, and the Key matrix and the Value matrix are obtained based on the sample text and overlapping region features corresponding to the sample images;
obtaining a total noise loss corresponding to the plurality of sample sets based on the noise losses corresponding to each sample in the plurality of sample sets;
adjusting parameters of an initial diffusion model based on the total noise loss, wherein the initial diffusion model comprises the initial noise addition network and the initial denoising network; and
in response to a stopping condition being met, stopping training to obtain the target diffusion model.

6. The method of claim 4, wherein for each sample image in each of the plurality of sample image groups, obtaining the overlapping region features corresponding to the sample image based on the sample image group to which the sample image belongs, comprises:
for the sample image, identifying a plurality of reference sample images from the sample image group;
for each reference sample image of the plurality of reference sample images, determining a local image from the reference sample image whose field of view overlaps with a field of view of the sample image;
mapping the local image to a coordinate system used by the sample image to obtain a target local image; and
obtaining the overlapping region features corresponding to the sample image based on the target local image.

7. The method of claim 4, wherein obtaining corresponding sample text for each sample image in the plurality of sample image groups comprises:
encoding, by a first image encoder, the sample image to obtain first sample image features; and
based on the first sample image features, obtaining the sample text corresponding to the sample image using a text generation model.

8. An electronic device comprising:
one or more processors; and
a memory coupled to the one or more processors, the memory storing programs that, when executed by the one or more processors, cause performance of operations comprising:
determining target text that indicates image content of a plurality of target images; and
for each initial image among a plurality of initial images, performing denoising processing on the initial image, using a target generation sub-model in a trained target diffusion model based on the initial image and the target text, to obtain one of the plurality of target images corresponding to the initial image;
wherein the target diffusion model is trained based on a plurality of sample sets, each of which comprises a plurality of sample images, overlapping region features and sample text corresponding to each of the plurality of sample images; the plurality of sample images in each of the sample sets are images captured of a same scene from different perspectives; the overlapping region features of each sample image of the plurality of sample images are image features determined based on a local image patch in a corresponding reference sample image whose field of view overlaps with a field of view of the sample image, and the reference sample image and the sample image belong to a same sample set of the plurality of sample sets.

9. The electronic device of claim 8, wherein for each initial image among the plurality of initial images, performing denoising processing on the initial image, using the target generation sub-model in the trained target diffusion model based on the initial image and the target text, to obtain one of the plurality of target images corresponding to the initial image, comprises:
through the target generation sub-model and based on camera parameter information corresponding to the initial image, the initial image, and the target text, obtaining the one of the plurality of target images from a perspective corresponding to the camera parameter information, wherein the plurality of initial images correspond to different camera parameter information and the plurality of sample sets further comprises the camera parameter information corresponding to each sample image.

10. The electronic device of claim 8, wherein the target generation sub-model comprises a target image encoder, a target image decoder, a target text encoder, and a target denoising network; performing denoising processing on the initial image, using the target generation sub-model in the trained target diffusion model based on the initial image and the target text, to obtain one of the plurality of target images corresponding to the initial image comprises:
encoding, by the target image encoder, the initial image to obtain initial image features;
encoding, by the target text encoder, the target text to obtain text features;
denoising, by the target denoising network, the initial image features based on the initial image features and text features to obtain denoised initial image features; and
decoding, by the target image decoder, the denoised initial image features to obtain the one of the plurality of target images corresponding to the initial image.

11. The electronic device of claim 8, wherein the operations further comprise:
obtaining a plurality of sample image groups and corresponding sample text for each sample image in the plurality of sample image groups, wherein each sample image group among the plurality of sample image groups comprises a plurality of sample images captured of the same scene from different perspectives;
for each sample image in each of the plurality of sample image groups, obtaining the overlapping region features corresponding to the sample image based on the sample image group to which the sample image belongs;
based on a plurality of sample sets obtained, performing training to obtain the target diffusion model, wherein each sample in the plurality of sample sets comprises a plurality of sample images, overlapping region features, and sample text corresponding to the sample images.

12. The electronic device of claim 11, wherein based on the obtained plurality of sample sets, performing training to obtain the target diffusion model comprises:
for each sample in the plurality of sample sets, adding noise on sample images in the sample using an initial noise addition network to obtain a noised feature map;
denoising the noised feature map using an initial denoising network based on the sample text and overlapping region features corresponding to the sample images to obtain a noise loss corresponding to the sample images, wherein the initial denoising network is configured to perform denoising based on an output of cross-attention, the output is obtained based on a Query matrix, a Key matrix, and a Value matrix, the Query matrix is obtained based on the sample images, and the Key matrix and the Value matrix are obtained based on the sample text and overlapping region features corresponding to the sample images;
obtaining a total noise loss corresponding to the plurality of sample sets based on the noise losses corresponding to each sample in the plurality of sample sets;
adjusting parameters of an initial diffusion model based on the total noise loss, wherein the initial diffusion model comprises the initial noise addition network and the initial denoising network; and
in response to a stopping condition being met, stopping training to obtain the target diffusion model.

13. The electronic device of claim 11, wherein for each sample image in each of the plurality of sample image groups, obtaining the overlapping region features corresponding to the sample image based on the sample image group to which the sample image belongs, comprises:
for the sample image, identifying a plurality of reference sample images from the sample image group;
for each reference sample image of the plurality of reference sample images, determining a local image from the reference sample image whose field of view overlaps with a field of view of the sample image;
mapping the local image to a coordinate system used by the sample image to obtain a target local image; and
obtaining the overlapping region features corresponding to the sample image based on the target local image.

14. The electronic device of claim 11, wherein obtaining corresponding sample text for each sample image in the plurality of sample image groups comprises:
encoding, by a first image encoder, the sample image to obtain first sample image features; and
based on the first sample image features, obtaining the sample text corresponding to the sample image using a text generation model.

15. A non-transitory computer-readable storage medium storing instructions that, when executed by at least one processor of an electronic device, cause the at least one processor to perform a multi-view image generation method, the method comprising:
determining target text that indicates image content of a plurality of target images; and
for each initial image among a plurality of initial images, performing denoising processing on the initial image, using a target generation sub-model in a trained target diffusion model based on the initial image and the target text, to obtain one of the plurality of target images corresponding to the initial image;
wherein the target diffusion model is trained based on a plurality of sample sets, each of which comprises a plurality of sample images, overlapping region features and sample text corresponding to each of the plurality of sample images; the plurality of sample images in each of the sample sets are images captured of a same scene from different perspectives; the overlapping region features of each sample image of the plurality of sample images are image features determined based on a local image patch in a corresponding reference sample image whose field of view overlaps with a field of view of the sample image, and the reference sample image and the sample image belong to a same sample set of the plurality of sample sets.

16. The non-transitory computer-readable storage medium of claim 15, wherein for each initial image among the plurality of initial images, performing denoising processing on the initial image, using the target generation sub-model in the trained target diffusion model based on the initial image and the target text, to obtain one of the plurality of target images corresponding to the initial image, comprises:
through the target generation sub-model and based on camera parameter information corresponding to the initial image, the initial image, and the target text, obtaining the one of the plurality of target images from a perspective corresponding to the camera parameter information, wherein the plurality of initial images correspond to different camera parameter information and the plurality of sample sets further comprises the camera parameter information corresponding to each sample image.

17. The non-transitory computer-readable storage medium of claim 15, wherein the target generation sub-model comprises a target image encoder, a target image decoder, a target text encoder, and a target denoising network; performing denoising processing on the initial image, using the target generation sub-model in the trained target diffusion model based on the initial image and the target text, to obtain one of the plurality of target images corresponding to the initial image comprises:
encoding, by the target image encoder, the initial image to obtain initial image features;
encoding, by the target text encoder, the target text to obtain text features;
denoising, by the target denoising network, the initial image features based on the initial image features and text features to obtain denoised initial image features; and
decoding, by the target image decoder, the denoised initial image features to obtain the one of the plurality of target images corresponding to the initial image.

18. The non-transitory computer-readable storage medium of claim 15, wherein the method further comprises:
obtaining a plurality of sample image groups and corresponding sample text for each sample image in the plurality of sample image groups, wherein each sample image group among the plurality of sample image groups comprises a plurality of sample images captured of the same scene from different perspectives;
for each sample image in each of the plurality of sample image groups, obtaining the overlapping region features corresponding to the sample image based on the sample image group to which the sample image belongs;
based on a plurality of sample sets obtained, performing training to obtain the target diffusion model, wherein each sample in the plurality of sample sets comprises a plurality of sample images, overlapping region features, and sample text corresponding to the sample images.

19. The non-transitory computer-readable storage medium of claim 18, wherein based on the obtained plurality of sample sets, performing training to obtain the target diffusion model comprises:
for each sample in the plurality of sample sets, adding noise on sample images in the sample using an initial noise addition network to obtain a noised feature map;
denoising the noised feature map using an initial denoising network based on the sample text and overlapping region features corresponding to the sample images to obtain a noise loss corresponding to the sample images, wherein the initial denoising network is configured to perform denoising based on an output of cross-attention, the output is obtained based on a Query matrix, a Key matrix, and a Value matrix, the Query matrix is obtained based on the sample images, and the Key matrix and the Value matrix are obtained based on the sample text and overlapping region features corresponding to the sample images;
obtaining a total noise loss corresponding to the plurality of sample sets based on the noise losses corresponding to each sample in the plurality of sample sets;
adjusting parameters of an initial diffusion model based on the total noise loss, wherein the initial diffusion model comprises the initial noise addition network and the initial denoising network; and
in response to a stopping condition being met, stopping training to obtain the target diffusion model.

20. The non-transitory computer-readable storage medium of claim 18, wherein for each sample image in each of the plurality of sample image groups, obtaining the overlapping region features corresponding to the sample image based on the sample image group to which the sample image belongs, comprises:
for the sample image, identifying a plurality of reference sample images from the sample image group;
for each reference sample image of the plurality of reference sample images, determining a local image from the reference sample image whose field of view overlaps with a field of view of the sample image;
mapping the local image to a coordinate system used by the sample image to obtain a target local image; and
obtaining the overlapping region features corresponding to the sample image based on the target local image.
